(19) United States
(12) Patent Application Publication
(10) Pub. No.: US 2009/0186217 A1
(43) Pub. Date: Jul. 23, 2009

(54) Article Comprising a Polymer Substrate and a Co-Extruded Polymer Coating

(75) Inventors: Ryszard Brzoskowski, Acton, MA (US); Yundong Wang, Lancaster, MA (US); Joseph Spuria, Auburn, NH (US)

Correspondence Address: NIXON & VANDERHYE, PC, 901 NORTH GLEBE ROAD, 11TH FLOOR, ARLINGTON, VA, 22203, US

(73) Assignee: DSM IP ASSETS B.V., Heerlen (NL)

(21) Appl. No.: 12/295,419

(22) PCT Filed: Mar. 30, 2007
(86) PCT No.: PCT/EP2007/002867

§ 371 Date: Feb. 6, 2009

Related U.S. Application Data
(60) Provisional application No. 60/787,536, filed on Mar. 31, 2006.

(30) Foreign Application Priority Data
Mar. 31, 2006 (EP) 06075825.7

(51) Int. Cl. B32B 27/08; B29C 47/06

(52) U.S. Cl. 428/339; 428/500; 264/176.1

(57) ABSTRACT

The present invention relates to an article comprising a polymer substrate and a co-extruded polymer coating. The polymer substrate is for example manufactured from a thermoset rubber, a styrene based thermoplastic elastomer, an olefinic based thermoplastic elastomer or mixtures of these polymers. The co-extruded coating comprises an optical brightener for example a fluorescent agent. The co-extruded coating for example has a thickness smaller than 700 micrometer. The article is for example used in automotive applications, in building and construction applications, in packaging, in food applications, consumer applications, in medical applications or in wire and cable applications. The present invention also relates to the use of the articles of the present invention in automotive sealing systems.

The present invention relates to an article comprising a polymer substrate and a co-extruded polymer coating. The present invention also relates to the use of the article in automotive applications, in building and construction applications, in packaging, in food applications, consumer applications, in medical applications or in wire and cable applications. The present invention further relates to a process for the manufacturing of the article.

An article comprising a polymer substrate and a co-extruded polymer coating is for example known from U.S. Pat. No. 5,441,685. U.S. Pat. No. 5,441,685 discloses an article being a window seal comprising a body part based on a thermoplastic elastomer and a low-friction and abrasion resistant coating, whereby the body part and the coating are co-extruded. A disadvantage of these window seals is that the coating, which is co-extruded with the body part, is often not present over the entire surface area which is supposed to be coated due to many technical reasons such as die pluggage, upset in the process, raw material contamination, etc. This can potentially lead to poor functional performance of the part such as poor abrasion resistance, high friction, worse freeze release properties and non-uniform surface gloss which causes major problems at the original equipment manufacturer (OEM). The prior art shows however that it is very difficult or not possible to detect whether the body part comprises uncoated parts on line during co-extrusion process. As an alternative, people take small sections of the co-extruded part and check the coating thickness visually or under optical microscope as a quality control (QC) procedure. This process is tedious and not reliable since this QC test is only performed at a certain frequency and only a small number of the produced parts can be inspected. It is quite possible that the production equipment is operated with part of the surface area not coated for quite some time before the problem is detected by the routine QC test.

The object of the present invention is to provide an article comprising a polymer substrate and a co-extruded polymer coating, which enables one to distinguish uncoated parts on the polymer substrate.

This object is achieved in that the coating comprises an optical brightener.

Surprisingly it has been found that the use of the optical brightener enables one to distinguish the uncoated parts on a polymer substrate comprising a co-extruded polymer coating. In fairly dark condition, areas or regions where the coating layer is missing remain dark while the coated regions emit blue fluorescent light under black light or UV light. It is even more surprising that the optical brightener works on coatings having dark color, more in particular it is surprising that the optical brightener works on coatings having black color. This makes it possible to detect very thin Co-extruded coatings on polymer substrates. This is a major advantage because one can implement an in-line detection system as part of the extrusion process to continuously monitor the presence or local absence of the coating. In this way it is possible to detect or catch the quality issues related to local absence of the coating right away, which avoids the above-mentioned problems at the OEM. In principle, it is also possible to estimate the thickness of the polymer coating by determining the level of the fluorescence glowing on the coating assuming that a fixed level of an optical brightener is used.

The optical brightener according to the present invention is preferably a fluorescent agent, which is a colorless to weakly colored organic compound that applied to a substrate, absorbs ultraviolet light and re-emit most of the absorbed energy in the blue region of visible spectrum to yield a bright appearance. Optical brighteners are also defined as fluorescent brightening agents or fluorescent whitening agents. The optical brighteners are commercially available from for example Ciba Specialty Chemicals and known under the name Uvitex™ and Tinopal™. The optical brightener is present in the polymer coating for example in an amount of between 50 ppm and 5000 ppm relative to the total weight of the polymer coating. Preferably it is present in an amount between 100 ppm and 2500 ppm, more preferably in an amount between 200 ppm and 2000 ppm relative to the total weight of the polymer coating.

The coating according to the present invention comprises at least one polymer for example chosen from a thermoplastic, a styrene based thermoplastic elastomer, an olefin-based thermoplastic elastomer or mixtures of these polymers.

Examples of thermoplastics are polyurethane, polystyrene and its derivatives, polyimide, polyamide, polyphenylene ether, polycarbonate, styreneacrylonitrile copolymers, polyoxymethylene, polyethylene terephthalate, polybutylene terephthalate, polyether ether ketone, polyphenylene oxide, fluoropolymers, or polyolefins such as polyethylene or polypropylene.

Examples of styrenic-based thermoplastic elastomers are for example block copolymers or terpolymers having one or two terminal polymeric blocks of for example polystyrene or poly-alpha-methylstyrene, and at least one non-terminal block of an elastomeric polymer, for example polybutadiene or polyisoprene. Typical examples of such block copolymers are those of general form polystyrene-polybutadiene-polystyrene (SBS), polystyrene--poly(ethylene/propylene) (SEP), polystyrene-polyisoprene-polystyrene (SIPS), poly-alpha-methylstyrene-polybutadiene-poly-alpha-methylstyrene, polystyrene-ethylene-propylene-polystyrene (SEPS), polystyrene-poly(ethylene/butylenes)-polystyrene (SEBS), polystyrene-poly(ethylene/ethylene/propylene)-b-polystyrene (SEEPS), or crosslinkable styrenic block copolymers produced by Kuraray Co., Ltd under the trade name Septon V. These styrene block copolymers are commercially available from Kraton Polymers LLC under the trademark KRATON and from Kuraray Co., Ltd under the trade name Septon. The styrene based thermoplastic elastomers may also comprise mixtures of SEP, SBS, SIPS, SEPS, SEEPS or SEBS with a polyolefin such as ethylene or propylene homo- or copolymers. Preferably polypropylene homo or copolymers are used.

Examples of olefin-based thermoplastic elastomers are thermoplastic elastomers comprising at least one polyolefin and at least one elastomer or thermoplastic elastomers comprising at least one polyolefin and at least one elastomer which is dynamically vulcanized (also called thermoplastic vulcanizates or TPV). Examples of commercially available TPVs are under the trade name of Sarlink, Kelprox, Santoprene, Vyram, Nexprene, Trexprene, Trexlink, Invision, etc., low or non crosslinking TPOs. These olefin-based thermoplastic elastomers are hereinafter fully disclosed.

It is also possible that the polymer coating comprises two polymers of two different melting points or two of the same polymers with different molecular weight. In that case powder or particles of a polymer such as nylon urethane, polyolefin or polystyrene with a high melting point or high molecular weight is mixed with a polymer such as nylon, urethane, polyolefin or polystyrene with a low melting point or lower molecular weight. An example is a polymer coating comprising ultra high molecular weight polyethylene mixed with high density polyethylene.

The coating may further include an additive selected from the group consisting of plasticizers, fillers and nucleating agents or lubricants. Suitable plasticizers are conventional paraffinic, naphthenic and aromatic processing oils. Suitable fillers and/or nucleating agents include calcium silicate, clay, kaolin, talc, silica, diatomaceous earth, powdered mica, barium sulfate, aluminum sulfate, calcium sulfate, basic magnesium carbonate, glass fibers, carbon fibers, nano-clay, nano-particles, nano-tubes, provided the filler is used in an amount small enough not to adversely affect either the hardness or the coefficients of friction of the polymer coating. Preferred silica's, which may be used, are micronized silica, fumed silica, a dry process-white carbon referred to as “white carbon.”, a wet-process white carbon and synthetic silicate-type white carbon. Preferably the silica or any other filler is used in an amount small enough not to adversely affect either the hardness or the coefficients of friction. Suitable inorganic lubricants are molybdenum disulfide and graphite; organic lubricants include higher fatty acids such as stearamide, oxystearamide, oleylamide, erucylamide, laurylamide, palmitylamide, methylol amides, fluoropolymer additives, fluoropolymer solid particles such as PTFE particles, silicone additives in liquid or solid forms, medium and high molecular weight siloxane particles, paraffin wax, and olefin wax such as polyethylene wax and polypropylene wax.

The coating comprising the optical brightener is for example manufactured by melt blending the polymer and the optical brightener in conventional mixing equipment for example roll mills, Banbury mixers, Brabender mixers, continuous mixers for example a single screw extruder, a twin screw extruder, a Ferro Continuous mixer (FCM), and a Buss Kneader. The polymer(s) in pellet or powder form and optical brightner in liquid, pellet or powder form can be added to the mixer using separate feeders or a liquid injector. The optical brightener in liquid or powder form can be also preblended with a powder carrier such as filler for ease of dosing before melt blending with the polymer. If the polymer(s) is/are in the powder form, it can be blended directly with the optical brightner in a blender for example a ribbon blender, a Mixaco mixer, a Henschel mixer and a cement mixer before melt mixing. If the polymer(s) is/are in pellet form, it can be first coated with small amount of oil or plasticizer uniformly in a blender, whereafter the oil coated pellets can be further mixed or coated with the optical brightner in the powder form. The resulting mixture can be added to the melt mixer using one feeder. It can also be used as a polymer coating without going through a melt mixing step to make co-extruded parts or profiles.

Alternatively, the optical brightener can be in a concentrate form and added directly to the extruder together with the polymers through separate feeders or after “salt and pepper” dry blending to produce co-extruded parts or profiles. The carrier for the optical brightner concentrate can be the same as or different from the polymer(s) that makes up the major portion of the polymer coating.

The optical brightener may also be present in the liquid form. The polymer pellets or powder can be mixed with the liquid optical brightener before melt mixing or before direct co-extrusion to make co-extruded parts or profiles.

The coating according to the present invention for example has a thickness smaller than 700 micrometer, preferably a thickness between 5 and 500 micrometer. More preferably it has a thickness between 10 and 200 micrometer. Most preferably it has a thickness between 20 and 80 micrometer.

Preferably, both the co-extruded polymer coating and the polymer substrate have dark color, more preferably both the co-extruded polymer coating and the polymer substrate have a black color, most preferably both the co-extruded polymer coating and the polymer substrate are of about the same color. With dark color is meant a CIELAB L* value below 45, more preferably a CIELAB L* value below 40, even more preferably a CIELAB L* value below 35, even more preferably a CIELAB L* value below 30, in particular a CIELAB L* value below 25, more in particular a CIELAB L* value below 20. The CIELAB L* value may be as low as 1, but may for example be at least 5 or at least 10 or at least 15. With black color is meant a CIELAB L* value below 35, preferably below 30, more preferably below 25 and a CIELAB a* value between −4 and +4, preferably between −2 and +2 and a CIELAB b* value between −4 and +4, preferably between −2 and +2.

Within the framework of the invention with a CIELAB L* value, CIELAB a* value respectively CIELAB b* value is meant a CIELAB L* value, CIELAB a* value respectively CIELAB b* value measured using a BYK Gardner Color-guide instrument following ISO 7724-1984 standard using CIELAB color coordinates. The measurement shall be conducted at 23+/−2° C. and at a relative humidity of 50+/−5% under standard illuminant D-65, 10 degree observer, sphere geometry with specular included. The specimen for color measurement shall be prepared through extrusion or co-extrusion.

The polymer substrate according to the present invention for example comprises a polymer or blends of polymers of for example styrene based thermoplastic elastomers, olefin-based thermoplastic elastomers or thermoset rubbers.

Examples of styrenic based thermoplastic elastomers are disclosed herein above.

Examples of thermoset rubbers are polybutadiene, EP(D)M, styrene butadiene, isoprene, trans-isoprene, acrylonitrile rubber, halogenated rubber such as brominated or chlorinated isobutylene-isoprene copolymer rubber, urethane rubber, epichlorohydrine terpolymer rubber, polychloroprene, butadiene styrene vinyl pyridine rubber and natural rubber or mixtures thereof. Preferably EP(D)M is used.

Examples of olefin-based thermoplastic elastomers are thermoplastic elastomers comprising at least one polyolefin and at least one elastomer or thermoplastic elastomers comprising at least one polyolefin and at least one elastomer which may be dynamically vulcanized, hereinafter called a TPO or in case of vulcanisation a thermoplastic vulcanizate or TPV.

Examples of the polyolefin are homopolymers of ethylene or propylene, copolymers of ethylene and propylene, copolymers of ethylene and an alpha-olefin comonomer with 4-20 carbon atoms or copolymers of propylene and an alpha-olefin comonomer with 4-20 carbon atoms. In case of a copolymer, the content of propylene in said copolymer is preferably at least 75 wt. %. The polyolefin homo- and copolymers may be prepared with a Ziegler-Natta catalyst, a metallocene catalyst or with another single site catalyst. Preferably, polypropylene, polyethylene or mixtures thereof are used as polyolefin. More preferably polypropylene is used as polyolefin. The polypropylene may be linear or branched. Preferably a linear polypropylene is used. The Melt flow Rate (MFR) of the polypropylene preferably is between 0.1 and 100; more preferably between 0.1 and 50; even more preferably between 0.3 and 20 (according to ISO standard 1133 (230° C.; 2.16 kg load)).

The amount of polyolefin is for example less than 75% by weight relative to the total weight the thermoplastic elastomer. Preferably the amount of polyolefin is between 1 and 65% by weight, more preferably between 5 and 55% by weight relative to the total weight the thermoplastic elastomer.

Examples of the elastomers suitable in the olefin based thermoplastic elastomer are ethylene-propylene copolymers, hereinafter called EPM, ethylene-propylene-diene terpolymers, hereinafter called EPDM, styrene-butadiene-styrene rubber (SBS), nitrile butadiene rubber, isobutene-isoprene rubber, styrene-ethylene-butylene-styrene block copolymers (SEBS), butyl rubber, isobutylene-p-methylstyrene copolymers or brominated isobutylene-p-methylstyrene copolymers, natural rubber or blends of these. Preferably, EPDM or EPM is used as elastomer. Most preferably, EPDM is used as elastomer. The EPDM preferably contains 40-80 parts by weight ethylene monomer units, 58-18 parts by weight monomer units originating from an alpha-olefin and 2-12 parts by weight monomer units originating from a non-conjugated diene whereby the total weight of the ethylene monomer units, the alpha-olefin and the non-conjugated diene is 100. As alpha-olefin use is preferably made of propylene. As non-conjugated diene use is preferably made of dicyclopentadiene (DGCPD), 5-ethylidene-2-norbornene (ENB), vinylnorbornene (VNB), or mixture of these. In a vulcanized thermoplastic elastomer, the elastomer is dynamically vulcanized in the presence of a curing agent such as, sulfur, sulfurous compounds, metal oxides, mateimides, phenol resins or peroxides. These curing agents are known from the state of the art and are described in for example U.S. Pat. No. 5,100,947. It is also possible to use siloxane compounds as curing agent, examples of siloxane compounds are hydrosilane or vinylalkoxysilane. Examples of suitable peroxides are organic peroxides for example dicumyl peroxide, di-tert-butylperoxide, 2,5-dimethyl-(2,5-di-tert-butylperoxy)hexane, 1,3-bis(tert-butylperoxyisopropyl)benzene, 1,1-bis(tert-butylperoxy)-2,3,5-trimethylcyclohexane, benzoyl peroxide, 2,4-dichlorobenzoyl peroxide, tert-butyl peroxybenzoate, tert-butyl peroxyisopropylcarbonate, diacetyl peroxide, lauroyl peroxide, tert-butyl cumyl peroxide.

The amount of curing agent is preferably between 0.02 and 5% by weight and more preferably between 0.05 and 2% by weight relative to the total weight of the thermoplastic elastomer. A co-agent may also be used during vulcanization of the elastomer. Examples of suitable co-agents are divinyl benzene, sulphur, p-quinondioxime, nitrobenzene, diphenylguanidine, triarylcyanurate, trimethylolpropane-N,N-m-phenylenedimaleimide, ethyleneglycol dimethacrylate, polyethylene dimethacrylate, trimethylolpropane trimethacrylate, arylmethacrylate, vinylbutylate and vinylstearate. The amount of co-agent is preferably between 0 and 2.00% by weight of the total weight of the thermoplastic elastomer composition.

The degree of vulcanization of the elastomer can be expressed in terms of gel content. The gel content is the ratio of the amount of non-soluble elastomer and the total amount of elastomer (in weight) of a specimen soaked in an organic solvent for the elastomer. A method for measuring the gel content is described in U.S. Pat. No. 5,100,947. Herein a specimen is soaked for 48 hours in an organic solvent for the elastomer at room temperature. After weighing of both the specimen before soaking and its residue, the amount of non-soluble elastomer and total elastomer can be calculated, based on knowledge of the relative amounts of all components in the thermoplastic elastomer composition. The elastomer in the dynamically vulcanized thermoplastic elastomer is for example at least partly vulcanized and for instance has a gel content between 60 and 100%. Preferably the elastomer is vulcanised to a gel content higher than 70%. More preferably to a get content higher than 90%. Even more preferably the elastomer is vulcanised to a gel content of at least 95%.

The thermoplastic elastomer or dynamically vulcanised thermoplastic elastomer can be prepared by melt mixing and kneading the polyolefin, the elastomer and optionally additives customarily employed by one skilled in the art. Melt mixing and kneading may be carried out in conventional mixing equipment for example roll mills, Banbury mixers, Brabender mixers, continuous mixers for example a single screw extruder, a twin screw extruder and the like. Preferably, melt mixing is carried out in a twin-screw extruder. After the polyolefin, the elastomer and optionally additives have been properly dispersed; the curing agent is added to initiate the dynamic vulcanization. The thermoplastic elastomer or dynamically vulcanised thermoplastic elastomer may also be prepared by melt mixing the polyolefin, the elastomer and optionally additives in one step. By one step is meant that the polyolefin, the elastomer, the curing agent and optionally other additives are fed by feeders to a continuous mixer at the same time. The polyolefin may however also be added partly before and partially after the vulcanization. An oil may for example be added before, during or after the vulcanization. The oil may however also be added partly before and partially after the vulcanization. The dynamically vulcanised thermoplastic elastomer for example has hardness between 30 Shore A and 60 shore D. Preferably a hardness between 40 shore A and 50 Shore D. More preferably hardness between 60 Shore A and 40 Shore D.

The polymer substrate for example relates to a body part of a weather strip, sheets, foils or tubes.

The present invention further relates to the use of the article in packaging, automotive sealing system applications, medical applications, in building and construction, in wire and cables. Examples of automotive sealing system applications are window seals, door seals, sunroof seals, hood seals, trunk seals, etc. for a motor vehicle. Examples of medical applications are surgical drapes, films or foils. Examples of applications in building and construction are window and door seals.

Preferably the article according to the present invention is a weather strip comprising a body part based on a polymer and a co-extruded polymer coating whereby the coating comprises an optical brightener. The body part may comprise the same polymers or polymer mixtures as herein above described for the polymer substrate. Preferably, olefin-based thermoplastic elastomer are used. The co-extruded coating may comprise the same polymers or mixtures of polymers and additives as described herein above. Preferably the co-extruded coating comprises polyolefins such as polyethylene and polypropylene. The optical brightener is described as set out herein above. Preferably Uvitex OB from Ciba Specialty Chemicals is used as optical brightener. The optical brightener is for example present in an amount between 50 ppm and 5000 ppm relative to the total weight of the polymer coating. Preferably it is present in an amount between 100 ppm and 2500 ppm, more preferably in an amount between 200 ppm and 2000 ppm relative to the total weight of the polymer coating. The weather strip may also comprise metal reinforcement, filled polyolefin reinforcement for example, glass fiber filled polypropylene, talc or mica filled polypropylene.

In a preferred embodiment the body part of the weather strip is provided by an extrudable first TPV and may have a wide range of hardness from 30 Shore A to 80 Shore D, depending upon the particular application. In a belt-line strip, or in a channel for the glass of a window, the body part is relatively soft, preferably in the range from 50 Shore A to 35 Shore D. The co-extruded coating is provided by a layer of a second TPV, whereby the second TPV may be the same as or different from the first TPV used for the body, also comprises the optical brightener. In the melt-blended TPV (whether first or second TPV) a preferred polyolefin is polypropylene or polyethylene or mixture of both. A preferred elastomer is selected from the group of ethylene-propylene-non-conjugated diene (EPDM) rubber, styrenic block copolymer and butyl rubber. Other ingredients are possibly processing oil or ester which functions as a viscosity modifier, fillers, colorants, curing agent, antioxidants and other ingredients. Essential ingredients are the polyolefin, the elastomer and processing oil, the other ingredients being chosen to meet the specific requirements for a particular intended use or purpose. A preferred range of essential components based on 100 parts by weight of the formulated TPV are from 1 to 65 parts by weight polyolefin, from 10 to 60 parts by weight elastomer; and from 0 to 60 parts by weight processing oil. A TPV having a melting point in the range from 130° C. to 180° C. is present in a major amount by weight in the body as well as the coating of the weather strip. The first and second TPV are most preferably chosen from olefin based thermoplastic elastomers commercially available under the Sarlink®. The hardness of the first TPV for the body part of the weather strip is preferably less than 40 Shore C; the hardness of the second TPV for the coating is less than 70 Shore D.

The present invention further relates to a process for the manufacturing of an article comprising a polymer substrate and a co-extruded polymer coating or to a weather strip comprising the body part based on at least one polymer and a co-extruded polymer coating by co-extrusion or by crosshead extrusion. The co-extrusion or crosshead extrusion comprises the process steps of. (i) melt-blending a first polymer or polymers in a first barrel to form a first polymer melt (ii) extruding the first polymer melt under suitable extrusion conditions through a first extrusion die of predetermined cross-section to form the polymer substrate or body part of the weather strip: (iii) melt-blending a second polymer or polymers, the same as or different from the first but comprising the optical brightener, in a second barrel to form a second polymer melt (iv) extruding the second polymer melt under suitable extrusion conditions through the first extrusion die (co-extrusion) or a second extrusion die of predetermined cross-section (crosshead extrusion) to form a coating (v) and recovering the article or weather strip having its body part integrally bonded to the coating.

The present invention furthermore relates to the use of the articles according to the present invention in automotive applications, more specific in automotive sealing systems for example as door seals, trunk seals, sunroof seals, and window seals in motor vehicles.

The invention will be elucidated by means of the following examples and comparative experiment without being limited thereto.

The raw materials for these experiments are listed below in Table 1.

TABLE 1
Raw Materials

| | | | Mineral Oil - FHR |
|---|---|---|---|
| | Lubmer TM-80B | Uvitex OB | Ultra 1199 |
| Manufacturer | Tokiwa | Ciba Specialty | Flint Hill |
| | | Chemicals | Resources |
| Used as | Coating | Optical | Wetting Agent |
| | | Brightener | |
| Physical Form | Black Pellet¹ | Yellow Powder | Liquid |
| CAS # | | 7128-64-5 | |

¹CIELAB L* = 24.6, a* = 0.6, b* = 0.7 measured on a co extruded strip with a width of about 27 mm and with a total thickness of about 2 mm and with the thickness of the TM-80B layer being about 40-50 micrometer.

### Experiment 1

99.45 weight % Lubmer TM-80B was first mixed with 0.50 weight % mineral oil FHR Ultra 1199 in a gallon size sealable plastic bag. 500 ppm (0.05 wt %) Uvitex OB was then added to the TM-80B/mineral oil blend and mixed together by turning the bag many times over a 3-minute period.

The resulting blend was extruded into a flat 50 mm wide by 3 mm thick strips using a HaskeBuchler Rheocord system 40 equipped with a single screw extruder having a 19 mm diameter general purpose screw with L/D ratio of 28/1.

A fluorescent black light was used in a darkened room to view the sample strip for the presence of the optical brightening agent.

### Experiment 2

99.00 weight % TM-80B was mixed with 0.50 weight % mineral oil FHR Ultra 1199 in a gallon size sealable plastic bag. 5000 ppm (0.5 wt %) Uvitex OB was then added to the TM-80B/mineral oil blend and mixed together by turning the bag many times over a 3-minute period.

The resulting blend was extruded into a flat 50 mm wide by 3 mm thick strip using a HaakeBuchler Rheocord system 40 as described in experiment 1.

A fluorescent black light was used in a darkened room to view the sample strip for the presence of the optical brightening agent.

The extruded strips of experiments 1 and 2 comprising the 500 ppm and 5000 ppm of Uvitex OB fluoresced a bluish color under black light conditions. The 5000 ppm showed a more intense glow than the 500 ppm sample but both were easily seen in the dark environment.

### Experiment 3

An Uvitex OS concentrate consisting of 97 wt % TM-80B and 2.5 wt % Uvitex OS and 0.5 wt % of mineral oil was made by blending TM-80B and Uvitex OB by hand with the aid of a large 5-gallon bucket outfitted with an electric drill comprising a mixing element on the end of it.

Mineral oil was first poured onto the TM-80B pellets. The mixing drill was used to blend the wet pellets before the Uvitex OB Powder was added. The blend was further mixed for 10 minutes using the mixing drill until it was apparent that all of the pellets were coated with the powder uniformly.

Two coating compounds were then prepared by melt mixing TM-BOB with 4 and 2 wt % of the Uvitex OB concentrate using a 25 mm Berstorff intermeshing co-rotating twin screw extruder (44 UD) equipped with a strand pelletizer. The barrel temperature setting for the extruder was 232° C. These two coating compounds comprised 1000 ppm and 500 ppm Uvitex OS, respectively.

Two co-extrusion runs were then conducted with Sarlink 5765B4 as the polymer substrate through a 38.1 mm Killion single screw extruder and the coating compounds through a 31.8 mm Killion single screw extruder. The coating had a thickness of 50 micrometers. The 38.1 mm Killion single screw extruder was equipped with a 32 to 1 L/D barrier screw having maddox mixing head while the 31.8 mm Killion single screw extruder was equipped with a 24 to 1 L/D barrier screw having a maddox mixing head.

As the co-extrusion runs were in progress, the lights in the lab were turned off and a black fluorescent light was placed at the die exit and was used to determine if the Uvitex OB actually fluoresced and if the coating was present over the whole substrate.

The co-extruded strips with the coatings and Sarlink 5765B4 substrate fluoresced at 500 ppm loading of Uvitex GB and 1000 ppm loading of Uvitex OB. The level of fluorescence was stronger at 1000 ppm loading. The areas without the top coating showed no fluorescence glowing at all under black UV light.

### Experiment 4

An Uvitex OB concentrate was prepared using a 25 mm Berstorff intermeshing co-rotating twin screw extruder (44 L/D) equipped with a strand pelletizer as described below.

First 97 wt % of TM-80B was blended in a cement mixer with 0.5 wt % of mineral oil for 5 min to ensure uniform coating of the TM-80B pellets with the oil. 2.5 wt % of Uvitex OB powder was then added to the oil coated TM-80B pellets. The mixture comprising the above ingredients was mixed for additional 10 min to ensure uniform coating of the Uvitex OB powder over the pellets.

The resulting mixture was melt blended in a 25 mm Berstorff twin screw extruder at 300 rpm and 6.8 kg/hr throughput rate. The melt temperature was found to be around 242° C. The Uvitex OB concentrate prepared through melt blending showed a uniform pellet size and strong and uniform fluorescence glowing under black UV light.

Co-extrusion experiments were conducted using Sarlink 5765B4 as the polymer substrate through a 38.1 mm Killion single screw extruder and the polymer coating through a 31.8 mm Killion single screw extruder. The coating was 50 micrometers in thickness. The 38.1 mm Killion single screw extruder was equipped with a 32 to 1 L/D barrier screw having maddox mixing head while the 31.8 mm Killion single screw extruder was equipped with a 24 to 1 L/D barrier screw having a maddox mixing head. The coating compounds were prepared by salt and pepper blending of TM-80B with 2 and 4 wt % of the melt blended Uvitex OB concentrate in a cement mixer before the co-extrusion process.

The coating of the co-extruded strips was found to be uniform and showed uniform fluorescence glowing under black UV light. The coating with 1000 ppm Uvitex loading was found to glow stronger then the coating with 500 ppm Uvitex loading. The areas without the coating showed no fluorescence glowing at all under the same black UV light.

1. Article comprising a polymer substrate and a co-extruded polymer coating wherein the color of the polymer substrate and the co-extruded coating has a CIELAB L* value below 45 and wherein the coating comprises an optical brightener.

2. Article according to claim 1, wherein the color of the polymer substrate and the co-extruded coating has a CIELAB L* value below 35 and a CIELAB a* value between −4 and +4 and a CIELAB b* value between −4 and 4.

3. Article according to claim 1, wherein the substrate comprises a polymer chosen from a thermoset rubber, a styrene based thermoplastic elastomer or an olefinic based thermoplastic elastomer.

4. Article according to claim 3, wherein the olefinic based thermoplastic elastomer is dynamically vulcanized.

5. Article according to claim 1, wherein the thickness of the coating is between 5 and 500 micrometer.

6. Article according to claim 1, wherein the optical brightener is a fluorescent agent.

7. Article according to claim 1, wherein the brightener is present in an amount between 50 ppm and 5000 ppm relative to the total weight of the polymer coating.

8. Article according to claim 1, wherein the article is a weather strip.

9. Use of the article according to claim 1, in automotive applications, building and construction, medical applications, packaging, consumer applications and in wire and cable applications.

10. Use of the article according to claim 1, in automotive sealing systems.

11. Process for the manufacturing of an article according to claim 1, by co-extrusion or crosshead extrusion of the polymer coating onto the polymer substrate.
